(19) United States
(12) Patent Application Publication
(10) Pub. No.: US 2026/0187297 A1
(43) Pub. Date: Jul. 2, 2026

(54) SIMULATED SIZING AND SITING OF A PLURALITY OF NEW ENERGY GENERATION FACILITIES TO PROVIDE ELECTRICITY FOR AN INDUSTRIAL LOAD

(71) Applicant: Inventus Holidngs, LLC, Juno Beach, FL (US)

(72) Inventors: Ian J. Fiske, Jacksonville, FL (US); Kerry P. Wang, Juno Beach, FL (US); William G. Kemmerer, Juno Beach, FL (US); Alexander A.D. Kirsch, Minneapolis, MN (US); Keith J. Harding, Minneapolis, MN (US); Christopher G. Nunalee, Juno Beach, FL (US); Sriharsha Veeramachaneni, Juno Beach, FL (US); Jordan R. Love, Juno Beach, FL (US); Lowell Crosby Savage, III, Juno Beach, FL (US); A T M Sayfuddin, Juno Beach, FL (US); Duc P.H. Nguyen, Juno Beach, FL (US)

(21) Appl. No.: 19/004,760

(22) Filed: Dec. 30, 2024

(51) Int. Cl. G06F 30/13

(52) U.S. Cl. CPC G06F 30/13

(57) ABSTRACT

A system and method are provided for simulating the sizing and siting of energy generation facilities to supply electricity for a recommended industrial load. The method begins by accessing specific criteria for each land parcel in a portfolio and filtering out unviable parcels based on factors such as existing wind or solar installations, protected areas, or parcel size. An objective function is calculated to represent the overall cost of generating electricity to meet the load. The system executes multiple design simulations, generating random placements of energy facilities based on criteria like industrial load size and location, renewable energy resource availability, and transmission line proximity. For each simulation, the cost of construction and electricity delivery is calculated to identify the lowest possible cost. Using a probabilistic technique, the method approximates the global minimum cost and ranks each simulation by cost-efficiency, helping identify optimal land parcels for energy facility placement.

### FIELD OF THE DISCLOSURE

The present invention generally relates to using probabilistic techniques for approximating a global minimum cost for simulated sizing and siting of a plurality of new energy generation facilities to provide electricity for a recommend industrial load.

### BACKGROUND

Developing large-scale renewable energy projects is a complex and lengthy process, typically requiring over six years to complete. The development phase involves critical activities such as site acquisition, transmission studies, permitting, financing, and power purchase agreement negotiations.

Selecting optimal sites for renewable energy projects across large geographic areas is particularly challenging due to factors like resource availability, land suitability, transmission access, and market conditions, which can make many locations economically unviable. Historically, planning during the development phase has relied on manual processes, such as spreadsheet modeling, which are insufficient for addressing the vast number of variables and constraints. This often leaves planners unable to determine if the final designs are truly optimal.

The introduction of advanced technologies, such as generative AI and high-performance microchips, has added new layers of complexity. Large-scale data centers, or hyperscalers, now require significant amounts of electricity, often preferring renewable sources. These companies, along with utilities, need to identify the optimal mix of renewables, supplemental gas, and storage to power their facilities at the lowest cost. This necessitates not only efficient planning but also strategic placement of resources to minimize strain on the grid and meet renewable energy goals.

### SUMMARY OF THE INVENTION

The present invention introduces a novel method and system for optimizing the spatial arrangement of a new portfolio of power generation systems to supply electricity to a new load at the lowest cost. The load may be a new load to be built or a preexisting load. The load is typically an industrial load such as electrolyzers, data centers, hydrogen production facility, manufacturing plants, and battery storage farms. The portfolio of power generation systems and the recommended load are financially connected. In some examples, the portfolio of power generation systems and the recommended load are directly or indirectly electrically connected.

Aspects of the invention include determining the optimal location and size for each power generation system within the portfolio and the optimal location and size of the new projected load, ensuring the most cost-effective, efficient, and effective power distribution to meet a power requirement such as those for an electrolyzer.

More specifically, disclosed is a system and method for simulating the sizing and siting of a plurality of new energy generation facilities to provide electricity for a new industrial load. The method involves accessing specific criteria associated with each land parcel in a portfolio of land parcels and filtering the data to exclude unviable parcels based on factors such as installed wind turbines or solar panels, proposed wind or solar plants, the percentage of load served by renewable energy resources, designated protected areas, or small land parcels. The method calculates an objective function representing the overall cost to generate the required electricity for the recommended industrial load and executes a specified number of design simulations for new energy generation facilities with given generation capacities. These simulations generate random placements and sizes of energy generation facilities based on criteria such as the size and location of the industrial load, renewable energy resources, and transmission lines. For each placement, the method calculates the construction cost and delivery of the required electricity at the lowest possible cost. A probabilistic technique, such as simulated annealing techniques, approximates the global minimum cost, identifying a subset of land parcels that optimally meet the electricity needs. Each simulation is stored in an ordered list based on cost-efficiency relative to the objective function, facilitating effective planning for energy generation facilities.

The probabilistic technique to approximate a global minimum cost incorporates one or more constraints, including: a minimum electrical generation capacity of the new energy generation facilities as mandated by regional authorities, Independent System Operators (ISOs), Regional Transmission Organizations (RTOs), or a combination thereof; a minimum fraction of electricity supplied by renewable energy sources; a maximum allowable length of transmission lines; or a combination of these constraints.

The total number of simulations (N) may be executed in parallel up to a total number of jobs or until a time period expires. The total number of simulations, the time period, or both may be are settable by a user.

The claimed invention may further include receiving, via a graphical user interface (GUT), a user selection to automatically identify a combination of land parcels within the portfolio of land parcels on a map based on specific criteria. These criteria can include the amount of electricity required for the recommended industrial load, a quantity of fuel, a fuel type, a delivery location, or a combination thereof. The method further comprises outputting a display that shows an image of at least one selected parcel of land. This output involves automatically positioning a delineation over the combination of land parcels on the map displayed on the GUI, accounting for the location of the recommended industrial load, renewable energy sources, transmission lines, transport routes, and delivery locations. This functionality allows for a visually intuitive identification of suitable land parcels aligned with the specified criteria.

Another aspect of the invention may include in real-time, each of the design simulations (N) as a dynamic movie. This movie illustrates the process of automatically generating and displaying on the map displayed in the GUI. The display highlights the location of the recommended industrial load, the location of renewable energy sources, and the location of transmission lines, providing an animated visualization of the design simulations to enhance understanding and facilitate decision-making.

Aspects of the claimed invention may further include calculating the cost to construct the simulated placement of location of the recommended industrial load, the location of renewable energy sources, which includes at least one of the following: capital costs for constructing renewable energy sources, electrolyzers, and liquefiers; operating costs for all assets; transportation costs for hydrogen via pipeline, trucking, or train; the market price of hydrogen; offset revenues from excess energy sales; hydrogen production tax credits (PTCs), clean hydrogen production tax credits, or a combination of these factors.

The results may be displayed in various formats with various color overlays on maps illustrating the combination of the parcels of land with the highest ranking for development based on the criteria.

### BRIEF DESCRIPTION OF THE DRAWINGS

The accompanying figures, where like reference numerals, refer to identical or functionally similar elements throughout the separate views, and which, together with the detailed description below, are incorporated in and form part of the specification, serve to further illustrate various embodiments and to explain various principles and advantages all in accordance with the present disclosure, in which:

FIG. 1 depicts an interactive graphical user interface with a map of the State of Texas illustrating considerations of the types of considerations for green energy system construction, according to an example of the present invention;

FIG. 2 depicts a high-level flow diagram for evaluating various types of considerations using a simulated annealing algorithm, according to an example of the present invention;

FIG. 3 depicts a table illustrating various user design criteria used as input for the high-level flow diagrams of FIG. 2, according to an example of the present invention;

FIG. 4 depicts an input configuration file illustrating various financial data used as input for the high-level flow diagrams of FIG. 2, according to an example of the present invention:

FIG. 5 through FIG. 8 depict an interactive graphical user interface with a map of the State of Texas illustrating four different designs produced by the system using the flow of FIG. 2, according to an example of the present invention:

FIG. 9 depicts a high-level flow diagram for evaluating various designs created from FIG. 2, according to an example of the present invention;

FIG. 10 through FIG. 13 depict an interactive graphical user interface with a map of the State of Texas illustrating various permutations of designs created by FIG. 2 and the evaluations performed by FIG. 9, according to an example of the present invention;

FIG. 14 depicts an interactive graphical user interface with a side-by-side comparison of the various permutations of designs created by FIG. 2 and the evaluations performed by FIG. 9, according to an example of the present invention:

FIG. 15A and FIG. 15B depict a flow chart 1500 for simulated sizing and siting of a plurality of new energy generation facilities to provide electricity for an industrial load, according to an example of the present invention; and

FIG. 16 illustrates a block diagram of a processing system for carrying out portions of the present invention.

### DETAILED DESCRIPTION

As required, detailed embodiments are disclosed herein; however, it is to be understood that the disclosed embodiments are merely examples and that the systems and methods described below are embodied in various forms. Therefore, specific structural and functional details disclosed herein are not to be interpreted as limiting but merely as a basis for the claims and as a representative basis for teaching one skilled in the art to variously employ the disclosed subject matter in virtually any appropriately detailed structure and function. Further, the terms and phrases used herein are not intended to be limiting but rather to provide an understandable description.

### Non-Limiting Definitions

Generally, the terms “a” or “an”, as used herein, are defined as one or more than one. The term plurality, as used herein, is defined as two or more than two.

The term “adapted to” describes the hardware, software, or a combination of hardware and software that is capable of, able to accommodate, to make, or that is suitable to carry out a given function.

The term “annealing algorithm” or “simulated annealing” is defined as a probabilistic technique for approximating the global optimum of a given function.

The term “another”, as used herein, is defined as at least a second or more.

The term “configured to” describes the hardware, software, or a combination of hardware and software that is adapted to, set up, arranged, built, composed, constructed, designed, or that has any combination of these characteristics to carry out a given function.

The term “coupled,” as used herein, is defined as “connected,” although not necessarily directly, and not necessarily mechanically.

The term “displaying in real-time” refers to the capabilities of computers to analyze vast amounts of data and, after completing the analysis, present results to a display with no noticeable delay. This is something no group of humans can do at that speed or scale.

The term “energy generation system” means an item or facility that produces electricity, at least part of the time. Examples of new energy generation facilities include wind farms, solar farms, energy storage including batteries (when they are discharging), synthetic natural gas power generation facilities, and nuclear plants.

The term “fatal flaw” or “low score escalators” means that one of the land characteristics for a given parcel of land makes it entirely undesirable for development, even if the other land characteristics score high. For example, if the landowner is listed as a U.S. National Park, this parcel of land, in general, is not feasible for development.

The term “independent system operator” or “ISO” is an organization formed at the recommendation of the Federal Energy Regulatory Commission. In the areas where an ISO is established, it coordinates, controls, and monitors the operation of the electrical power system, usually within a single U.S. slate but sometimes encompassing multiple states. Regional Transmission Organizations (RTOs) typically perform the same functions as ISOs but cover a larger geographic area.

The terms “including” and “having,” as used herein, are defined as comprising (i.e., open language).

The term “land characteristics” includes size, ownership, tree coverage, elevations, terrain, buildable land, location of nearby renewable projects, and the owner's willingness or sentiment to sell rights.

The term “load” means an item that consumes electricity, at least part of the time. Examples of loads include electrolyzers, data centers, hydrogen production facilities, manufacturing plants (e.g., semiconductor manufacturing plants), and battery storage farms (when they are charging).

The term “locational marginal pricing” or “LMP” is adapting wholesale electric energy prices to reflect the value of electric energy at different locations, accounting for the patterns of load, generation, and the physical limits of the transmission system.

The term “net capacity factor” or “NCF” is the ratio of actual electrical energy output over a given period of time divided by the theoretical continuous maximum electrical energy output over that period.

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “resource characteristics” includes the net capacity factor (NCF) of wind or solar, which describes the fraction of total capacity that is produced over the course of a typical year. Typical total capacities include 20, 25, 50, 75, 100, 150, 200, 250, 400 Megawatts. Note, solar capacities are typically on the lower end, and wind capacities are typically on the higher end of these typical capacities.

The term “simultaneous” means computations are carried out at the same time, which for larger data sets with various constraints, is not possible to be carried out completed by a group of humans and must be performed by a computer. For example, one human could not compute one simulation with all the constraints for thousands of various combinations of parcels of land across multiple counties and across multiple states with all the various criteria. It is infeasible for a human to calculate one simulation loop with one constraint, let alone perform it in parallel to a sort of global optimum.

The term “site and size” refers to the suggested location to place a system. The system can be either an energy generation system or an industrial load. The term size refers to the capacity. The capacity, typically measured in MegaWatts, is the output of an energy generation system or the required input for an industrial load.

The term “transmission characteristics” includes substation hardware costs, network upgrades, and grid tie-in costs, such as those to be compatible with Federal Energy Regulatory Commission Order 845.

The term “uniform data format” means data in a given format, whether date format, time format, currency format, scientific format, text format, or fractional format, so that all values of data are presented in a single consistent format for a given category or criteria.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined in methods consistent with various embodiments of the present device.

Although the elements in the following method claims, if any, are recited in a particular sequence with corresponding labeling unless the claim recitations otherwise imply a particular sequence for implementing some or all of those elements, those elements are not necessarily intended to be limited to being implemented in that particular sequence.

### Design Optimization for a Combination of New Energy Generation Facilities to Produce Electricity for an Industrial Load

In the case of an industrial load being green hydrogen, one important aspect is creating an optimized solution to deliver hydrogen at the lowest cost, which includes transmission, pipelines, and other transportation. Other types of industrial loads have other specific requirements, such as the size and location of industrial load, renewable energy resources, and transmission lines.

The software product, as described above, scores locations based on a marginal distribution across all possible customers. More specifically, the software evaluates, ranks, and displays ranked results for land parcels under consideration for energy generation facilities, such as renewable energy projects, industrial load locations such as locations for electrolyzer, data centers, battery storage, connecting transmission, and pipelines. The software includes automated processing of land data accumulated through various techniques to automate the evaluation and selection of optimum land parcels to be assembled into a site suitable for the construction of solar or wind farms. The processing includes the evaluation of criteria associated with assembling multiple parcels of land owned by one or more owners into land clusters that are evaluated to be suited for building energy generation facilities, such as renewable energy generation sites. The determined land clusters are displayed on a map along with their characteristics to assist in selection. The user can then specify other areas on the map adjacent to or separate from the identified clusters to see their scores and characteristics.

There are a myriad of considerations necessary when designing industrial loads, such as green hydrogen systems, battery storage systems, data centers, to find the low costs based on customer requirements. In the example of green hydrogen systems, the cost/kilograms of green hydrogen fuel based on customer requirements.

H2Viewer is the software that scores locations based on a marginal distribution of across all possible customers and the industrial load, such as green hydrogen is optimized for a specific customer/scenario to include where the renewable energy (wind, solar) farms are located, the location of electrolyzer, location of pipelines and delivery points and transmission lines. Further information on the H2Viewer software is described in the incorporated references.

One aspect of the present invention uses customer's selections for the capacity or size of an industrial load, the type of renewable energy, e.g., wind, solar, or a combination. In the case of green hydrogen the customer selections may further include the demand for either hydrogen or some hydrogen derivative efuel to perform optimization to find configurations or the combination, the configuration of renewables, and electrolyzer that gives us the lowest cost design and in that by the configuration of locations. The term locations means selecting out of all the available parcels, their size, and the location of delivery points.

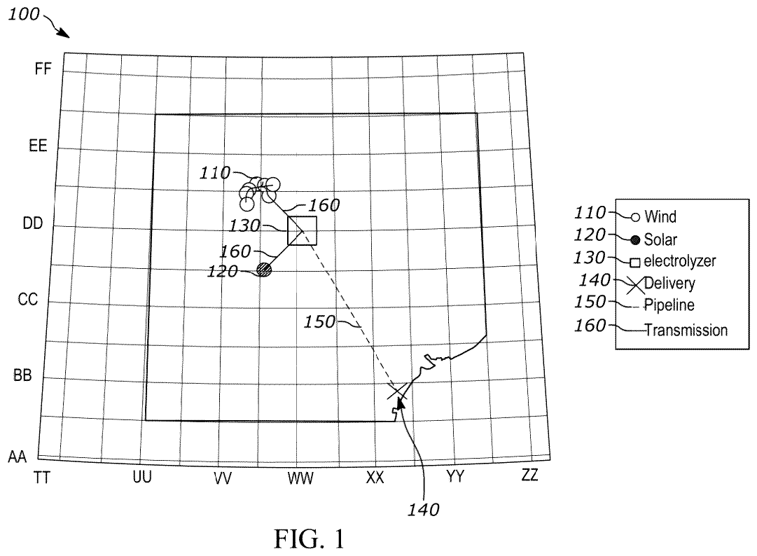

Referring now to FIG. 1, depicted is an example interactive graphical user interface 100 with a map of the State of Texas illustrating the types of components being considered for a green energy system. Green hydrogen is hydrogen produced by the electrolysis of water using renewable electricity. The production of green hydrogen causes significantly lower greenhouse gas emissions than the production of grey hydrogen, which is derived from fossil fuels without carbon capture. The considerations illustrated include deliver point, load, and energy generation systems. More specifically, the delivery point is Houston 140 through pipeline 150 from electrolyzer 130. Shown is a combination of solar 120 and wind 110 desired for a given electrolyzer size typically measured in Megawatts (MW).

In addition to the above, one aspect of the invention includes prospecting where to put these energy generation sites and the electrolyzer of the overall green hydrogen system. The system analyzes many different locations and sizes for each potential energy generation site and the electrolyzer and calculates the cost as it goes. The optimal system design provides the lowest delivered cost of the produced hydrogen.

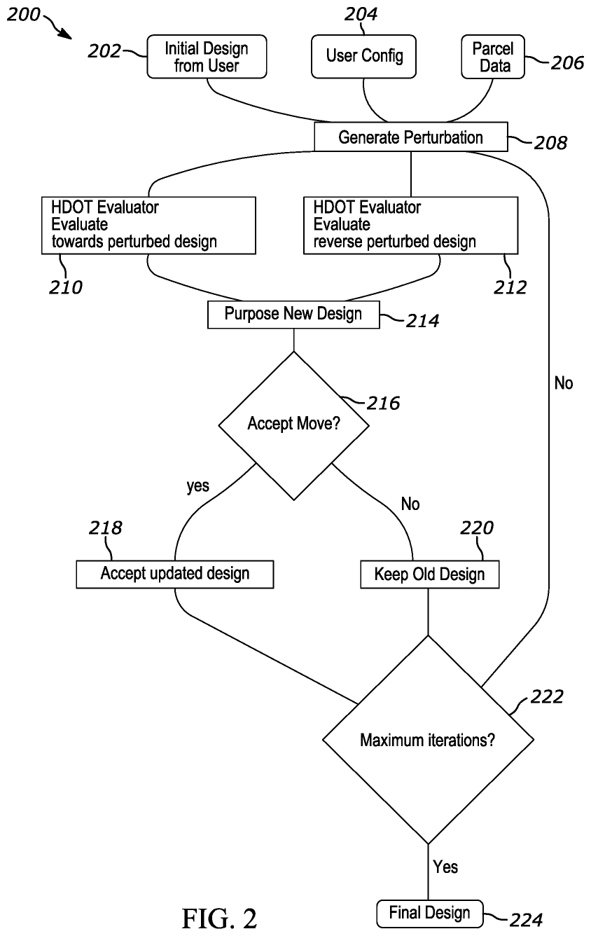

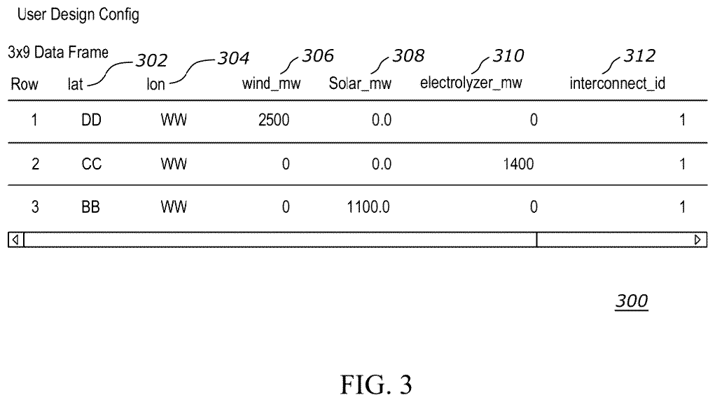

FIG. 2 depicts a high-level flow diagram 200 for evaluating various types of considerations using a simulated annealing algorithm to find the global optimum. The process begins with at least three sources of data 202, 204, and 206. The first source of data is an initial design 202 from the user Δn example of the initial design is table 300 shown in FIG. 3. Notice the variations such as location given with latitude 302, longitude 304, the amount of wind generation 306, the amount of solar generation 308, the size of the electrolyzer 310, and whether or not they are interconnected 312. The present invention addresses various customer requirements or initial designs to include:
Geographic location for fuel delivery point
Fuel type (e.g., gaseous or liquid H2, NH3, or eFuels)
Quantity (tons per year/day/month) and term (years)
Quality (100% green, mix of green hydrogen and grey hydrogen)

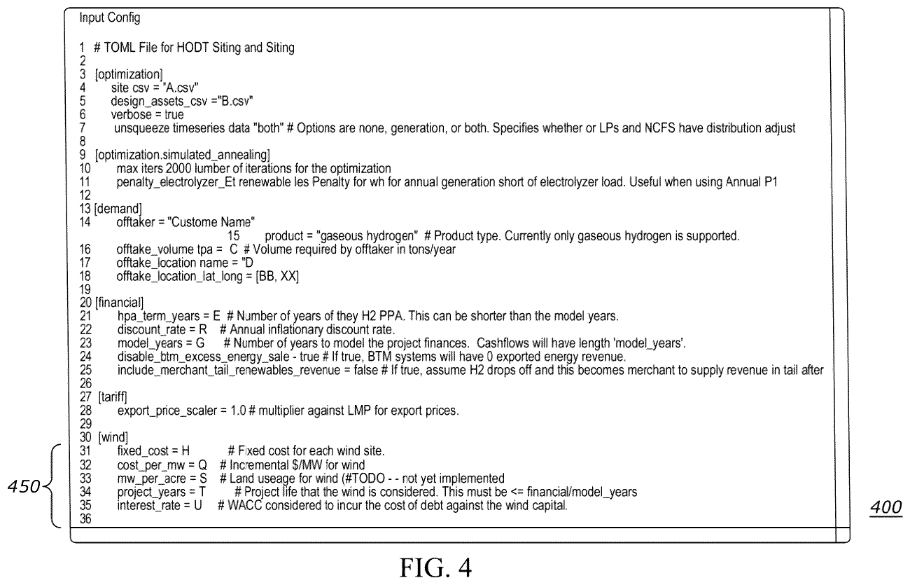

A second source of data is financial-related data, in this example in an input file contig 204. As shown in FIG. 4, an input configuration file 400 illustrates various settings for financial data used as input for the high-level flow diagrams of FIG. 2. The financial data includes offtaker pricing, discount rate, excess energy price, fixed costs, and more, as shown. The offtake typically buys power from a project developer at a negotiated rate for a specified term without taking ownership or operation of the system. The bottom 450 for each location shows the cost per acre to purchase or build there, the maximum amount of wind and solar at that location, and the size of an electrolyzer that can be fit on that parcel in terms of megawatts.

The present invention finds the lowest cost system to meet this demand. Costs include: capital costs to construct: renewables, hydrogen, electrolyzer, liquefier, operating costs for all assets, transport: pipeline, transmission, trucking, train offset by revenues: excess energy sales, H2 and clean hydrogen production tax credits (PTCs), and other financial details

A third source of data is data related to land parcels 206 as described above, including size, ownership, tree coverage, elevations, terrain, buildable land, location of nearby renewable projects, and the owner's willingness or sentiment to sell rights.

Unlike a brute force method or generally solving an allocation problem as was done previously, all these sources of data are fed into an annealing algorithm in step 208. The annealing algorithm is a metaheuristic optimization algorithm. The goal of simulated annealing is to find the global optimum (or a good approximation) of a given objective function in a large search space, even in the presence of complex, multimodal, or non-convex landscapes.

A simulated annealing has several unique aspects as follows:

Initialization: The algorithm starts with an initial solution or state. This could be randomly generated or chosen using some heuristic method.

Objective Function: A cost function or objective function is defined, which evaluates the quality of a solution. The objective function assigns a numerical value to each candidate solution, indicating how well it satisfies the optimization criteria.

Temperature Initialization: Simulated annealing introduces the concept of “temperature,” which controls the probability of accepting worse solutions during the search. Initially, the temperature is set to a high value.

Iterative Improvement: The algorithm iteratively explores the search space by making small changes to the current solution. These changes could involve swapping elements, perturbing parameters, or other modifications depending on the problem domain.

Acceptance Criterion: At each iteration, the algorithm evaluates the new solution and compares its objective function value with the previous solution. If the new solution is better (i.e., has a lower cost), it is always accepted. If the new solution is worse, it may still be accepted with a certain probability determined by the temperature and the magnitude of the difference in cost. This probabilistic acceptance allows the algorithm to escape local optima and explore the search space more effectively.

Cooling Schedule: The temperature is gradually reduced over time according to a predefined cooling schedule. This reduction in temperature decreases the probability of accepting worse solutions, leading the algorithm to converge toward better solutions as the search progresses.

Termination Criterion: The algorithm continues iterating until a termination criterion is met, such as reaching a maximum number of iterations, achieving a certain level of solution quality, or running out of computational resources.

Simulated annealing is a stochastic optimization algorithm, meaning that the final solution may vary between different runs of the algorithm due to its probabilistic nature. However, with appropriate tuning of parameters such as the initial temperature, cooling schedule, and acceptance probability function, simulated annealing can effectively explore complex search spaces and find high-quality solutions to optimization problems.

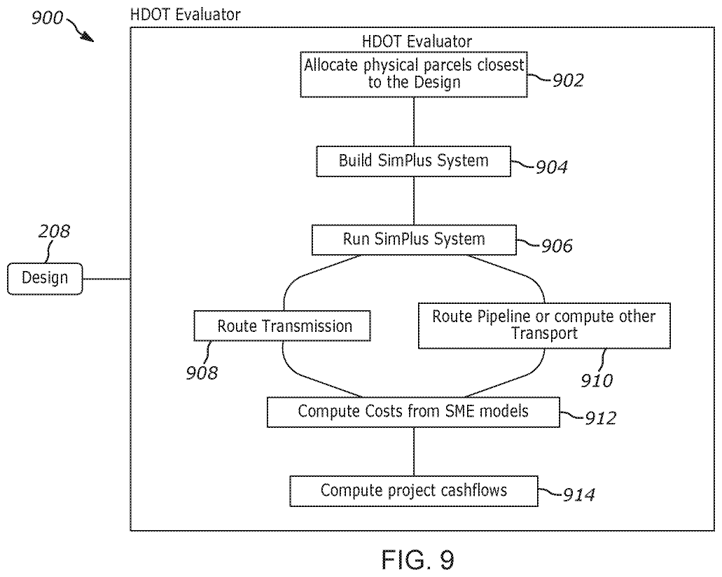

The process continues to steps 210 and 212. A Green Hydrogen Optimizer system is customized for a particular customer, as explained below with reference to FIG. 9, creates both a forward 210 and a backward 212 perturbation of the design using the annealing algorithm as shown to create a new proposed design 214. The perturbation is a random change from the initial design in terms of the sizes of the different generator electrolyzers and their locations. The system evaluates the perturbation in two directions: forward and reverse. Similar to a plus and the minus of that change in design. The design is an evaluation by running a simulator on a given design and running the full financial analysis on that design. The process goes to step 216.

Step 216 is a decision block. The user selects to accept or reject the proposed design 216. In the case in which the user accepts design 219, the process goes to step 222. Otherwise, if the user selects not to accept the proposed design 220, the process also goes to step 222.

In step 222, a test is made to see if the maximum number of user-selectable iterations have run or if the budget for computations has been exhausted. The process continues to step 224.

In step 224, the final design is produced

### Pseudo Code for Simulated Annealing

```
function SimulatedAnnealing(problem, initial_solution, initial_temperature,
cooling_rate):
    current_solution = initial_solution
    current_energy = problem.evaluate(current_solution)
    best_solution = current_solution
    best_energy = current_energy
    temperature = initial_temperature
  while temperature > 0:
    neighbor_solution = problem.generate_neighbor(current_solution)
    neighbor_energy = problem.evaluate(neighbor_solution)
    energy_difference = neighbor_energy − current_energy
  if energy_difference < 0 or random(0, 1) < exp(-energy_difference / temperature):
    current_solution = neighbor_solution
    current_energy = neighbor_energy
  if current_energy < best_energy:
    best_solution = current_solution
    best_energy = current_energy
  temperature *= cooling_rate
return best_solution
```

In this pseudocode:
problem—represents the optimization problem to be solved.
initial_solution—is the initial solution to start the algorithm.
initial_temperature—is the initial temperature or starting value of the system.
cooling_rate—is the rate at which the temperature decreases.
The generate_neighbor function generates a neighboring solution to the current solution. The evaluate function evaluates the energy (or cost) of a given solution.

This pseudocode captures the essence of the simulated annealing algorithm, where at each iteration, it probabilistically accepts worse solutions initially with a high probability, which decreases as the temperature decreases, allowing the algorithm to explore the solution space globally before converging towards the optimal solution.

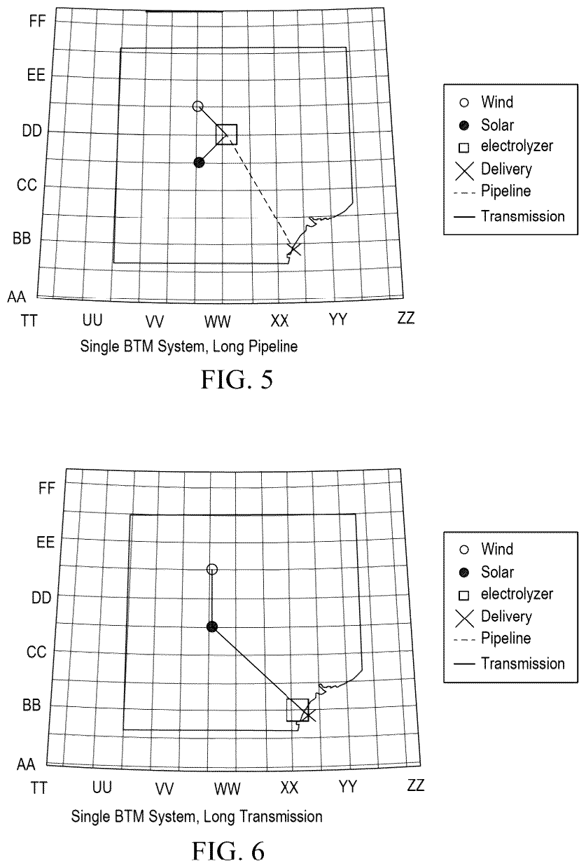

FIG. 5 through FIG. 8 depict an interactive graphical user interface 500, 600, 700, 800 with a map of the State of Texas illustrating four different designs produced by the system using the flow of FIG. 2.

More specifically. FIG. 8 illustrates a single behind-the-meter (BTM) system with a long delivery pipeline. In this scenario, a single behind-the-meter system interconnects a wind site, solar site, and electrolyzer facility. These connect to the grid in a single location. The electrolyzer is close to the generation but far from the customer location. Hence, this design produces a short transmission and long delivery pipeline.

FIG. 6 illustrates a single BTM system with long transmission. In this scenario, a single BTM system interconnects a wind site, solar site, and electrolyzer facility. These connect to the grid in a single location. The electrolyzer is far from the generation but close to the customer location. Hence, this design produces a long transmission and a short delivery pipeline.

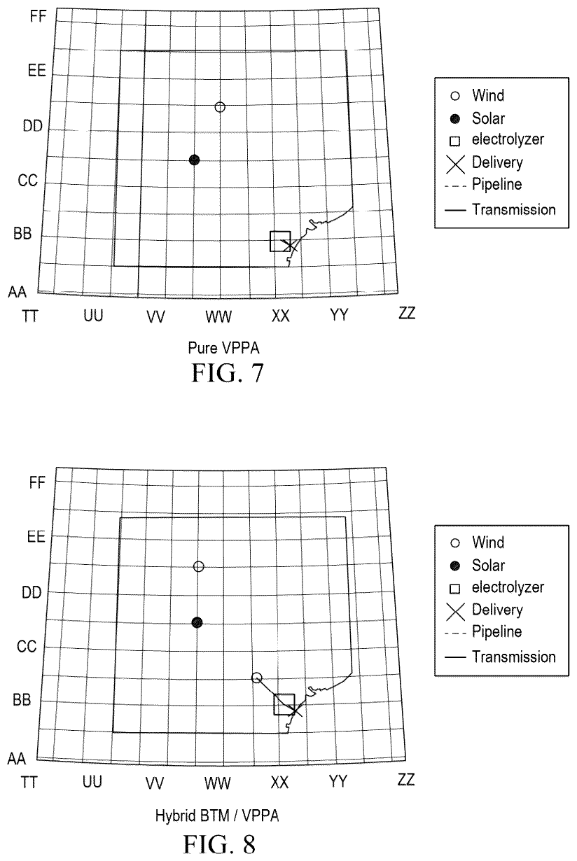

FIG. 7 illustrates a pure virtual power purchase agreement (VPPA) scenario in which each asset (wind site, solar site, and electrolyzer facility) is individually connected to the grid. Each separate asset settles financially independently on the grid.

FIG. 8 illustrates the simulated sizing and siting of a green hydrogen electrolyzer as the industrial load may consider hybrid solutions combining the VPPA and BIM designs. Here, there are VPPA assets-wind, and solar-as well as one BTM solar coupled with the electrolyzer. In this example, the green hydrogen electrolyzer is close to the delivery location, therefore a short pipeline is required

### Simulated Sizing and Siting of a Green Hydrogen Electrolyzer as the Industrial Load

FIG. 9 is a high-level flow diagram 900 for evaluating various designs created from FIG. 2 to generate electricity from the plurality of new energy generation facilities to produce electricity for the industrial load, the green hydrogen electrolyzer. The flow begins with receiving a current design from step 208. In step 902, the parcels of land that are physically closest to the initial design (or temperature of the annealing algorithm) are allocated. The process continues to step 904.

Step 904, a simulated green hydrogen electrolyzer is built. This is a computational model that represents the key features of the system. The process continues to step 906.

Step 906 the model simulates renewable energy generation at the selected sites, hydrogen production at the electrolyzer, and key financial transactions such as energy import/export costs, capital and operating expenses. The process takes two parallel paths to steps 908 and step 910, as shown.

In step 908, the route transmission is computed. Given the locations of all renewables generators and electrolyzers, a route is computed to electrically connect all of the components according to the required combination of direct grid-connected and behind-the-meter connected components. The process continues to step 912.

In step 912, the costs are calculated from the SME (small medium enterprise) models described below that, including electrolyzer CapEx (E&C), transmission CapEx (E&C), pipeline CapEx (E&C), and electrolyzer Opex (PDG). The process continues to step 912. The process flows to step 914.

Step 914, the cashflows are computed, and the process returns to step 214, in FIG. 2.

### Types of Data Used by Given Hydrogen Optimizer

The system uses data to help Green Hydrogen Optimizer identify the optimal or near-optimal solutions. A set of land parcels is viewed, each with attributes:
max_solar_mw
max_wind_mw
max_electrolyzer_mw
mean_ncf mean_imp
miles to interconnect
etc.

Market data including zonal LMPs and average fleet NCFs, and market data options
models3 electrolyzer CapEx (E&C)
transmission CapEx (E&C)
pipeline CapEx (E&C)
electrolyzer Opex (PDG)

### Green Hydrogen Optimizer Evaluator Details

Site Allocation: The first step in the evaluation is to convert the user's design into a set of actual sites from the sites_csv. Green Hydrogen Optimizer implements a greedy nearest-neighbor search that favors sites near the target location that can fit the entire desired MW. For speed. Green Hydrogen Optimizer uses a cached K-DTree data structure to find the nearest sites.

The computational simulation runs the green Hydrogen Optimizer runs a full hourly 1-year dispatch simulation. Green Hydrogen Optimizer Implements two new computational simulation components. The Green Hydrogen Optimizer Dispatcher implements the dispatch strategy, curtailing the electrolyzer if required. The Green Hydrogen Optimizer System represents the design, with each Computational Simulation BTMAC Coupled System modeling a single interconnected system. More specifically, BTM refers to Behind the Meter, and AC refers to Alternating Current system. This is the combination of two acronyms that are combined together BTMAC. A BTMAC system typically has wind and/or solar tied directly to a load (e.g., data center, electrolyzer) in an AC power system, with a single tie to the grid.

The cost of transmission is computed given an allocated design with simulation results, Green Hydrogen Optimizer. This requires a network design. Green Hydrogen Optimizer uses a simple transmission model to determine the required branches A minimal set of lines to connect all of the sites is determined. Use a minimum spanning tree (MST) algorithm to find this set. A DC power flow model is used to compute the power flow on these branches. These branch flows will be fed to the Engineering & Construction (E&C) transmission capital expenditures (CapEx) model.

Pipeline considerations are similar to transmission considerations. A Green Hydrogen Optimizer uses a simple routing model to compute the required length of the pipeline. The algorithm is as follows. Compute a weighted centroid of all electrolyzers, Run feeder pipelines from each electrolyzer to the centroid, and Run a backbone from the centroid to the customer.

The financial analysis includes computing cashflows. Green Hydrogen Optimizer uses a basic financial model that includes Capex for all components, Opex for all components, Excess energy sale, and Imported energy cost.

Tax incentives include Renewable PTCs and Hz PTCs. Other Tax Impacts include tax shield depreciation, and income tax.

### Market Prices, NCFs, and Challenges

An important factor in selecting the best locations for renewables and electrolyzers is the renewable resource and the price of import/exported energy. Therefore, this NCF and energy price data is of crucial importance.

Under Electric Reliability Council of Texas (ERCOT); large industrial loads are able to purchase energy at wholesale. Therefore, the strategy has been to use LMPs in ERCOT.

Some requirements of NCF and LMP data include: (1) the relationship (some call it correlations) between NCFs and L-MPs at a location represents reality (e.g., the data should come from the same time period) and (2) the price data should (at least attempt to) model the effect of price suppression and inflation due to adding large renewables or loads.

Univariate distributions of price and NCF data should be realistic over time and over space.

The system has good NCF and LMP data, but the NCF data is from a different time period than its LMP data (bad correlations). PMI provided NCF and LMP data that align. However, these are spatially averaged over zones and, therefore, lack variability (spatially and temporally). Modeling incremental price suppression and inflation due to additions is a huge project that is beyond the scope of what PMI can provide in a reasonable timeframe.

LMP and NCF Data Complies Under Pressure to make progress despite the above challenges. The Green Hydrogen Optimizer currently uses the following strategy. The system starts with PMI's zonal data to get the correct correlations between NCF and LMPs. To obtain a realistic univariate distribution (spread), a transformation is applied such that the quantiles of the transformed data match the realistic (full variability data). The mean is adjusted at each site to match those from the system to add to spatial variability. A price-dampening formula is used to model the effects of price suppression and decrease the price as the excess generation increases.

As part of an evaluator wrap-up and timing and given the complexity of the above evaluator, a computational simulation system is built, including market data adjustments and neighbor search (in allocation). The system runs a full-year simulation of a simplified dispatch model. The pipeline and transmission routing, DC power flow. SME models and financial roll-ups

The present invention runs about 20-30 ms using the Julia programming language. This process may be even faster depending on the language in which the software is implemented and the type of computing hardware used.

### Data Center Algorithm

In one example, the present invention brings together the factors, including the proximity to fiber/population center/substation, land parcel characteristics, and more, that influence the viability of data center prospects, ultimately recommending the best properties to pursue these projects. Parcels within a small radius (e.g., typically 50 miles) of the center of major metro areas are filtered and scored based on their proximity to fiber and transmission substations and land characteristics (number of buildings in the parcel, the concentration of buildable land for a data center, the concentration of buildable land for a 25 MW solar plant).

### Interactive Graphical User Interface

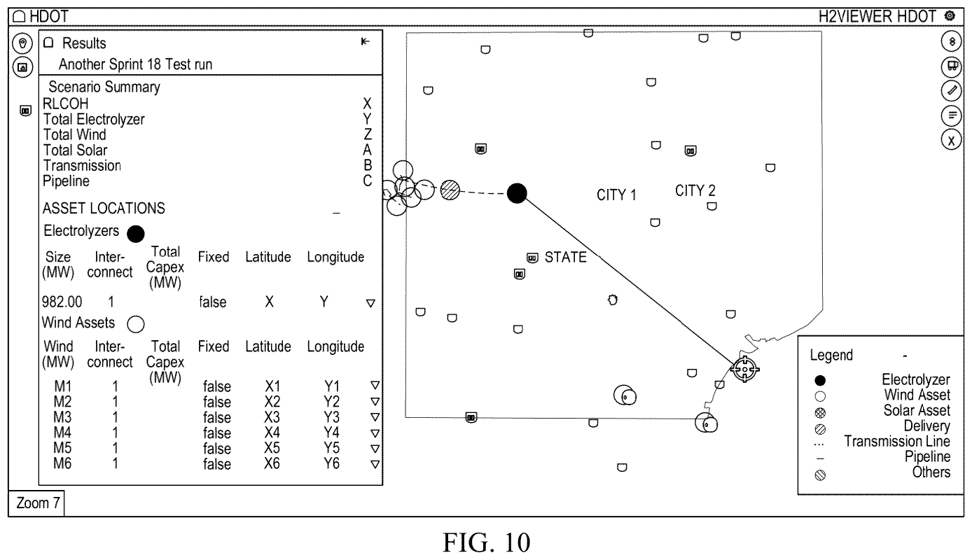

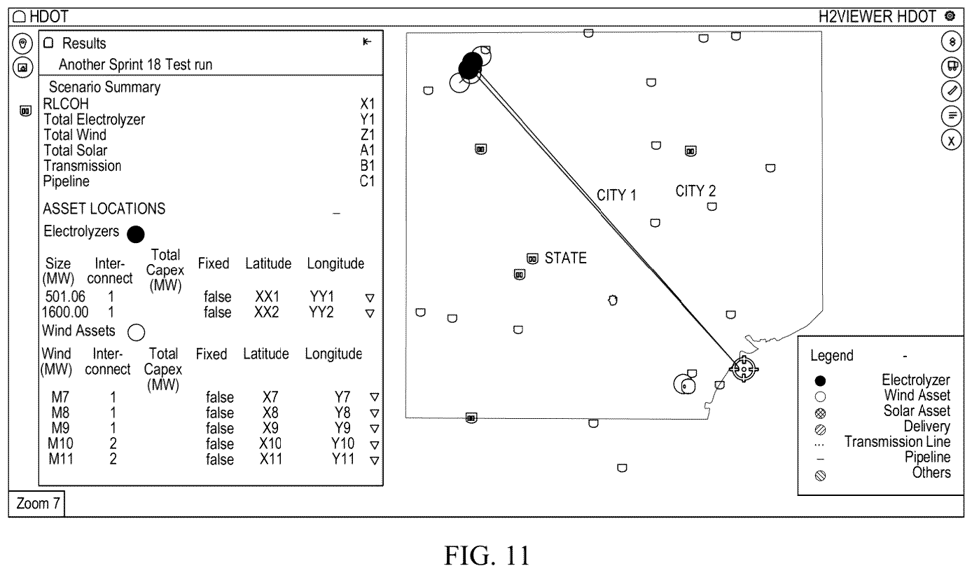

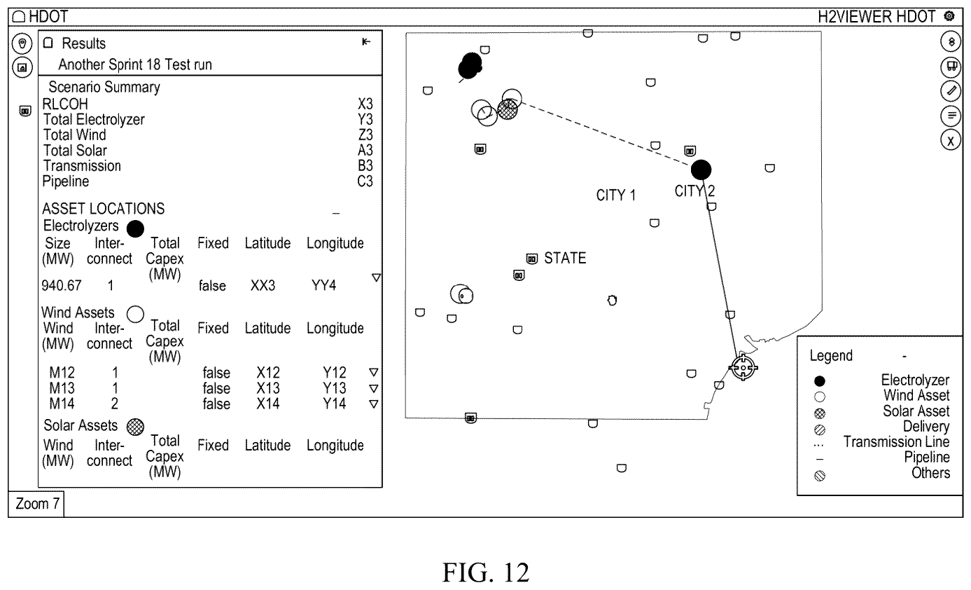

FIG. 10 through FIG. 13 is an interactive graphical user interface 1000, 1100, 1200, 1300 with a map of the State of Texas illustrating various permutations of designs created by the optimizer in FIG. 2 and the evaluations performed by FIG. 9.

The system incorporates several interactive graphical user interfaces (GUIs) to facilitate user input and automatically generate a visual delineation around the land parcels based on specific criteria indicating a highest combined score to meet the electricity requirements for a new energy generation facility. The process leverages the trained algorithm to display a series of dynamic screens, effectively presenting a “movie” of the simulated siting process on a map in real-time. The system can automatically generate and position delineations over combinations of land parcels on the displayed map, illustrating each simulated siting in the sequence. Note that not all iterations need to be shown. Rather only iterations that improve over previous iterations or every ten iterations may be shown. The system may automatically generate and position a delineation over the combination of land parcels on the map displayed on the GUI of the series of simulated sitings. A plurality of icons are is in the GUI for selecting each type of generation and load, transmission, and delivery to be automatically positioned over identifying land parcels

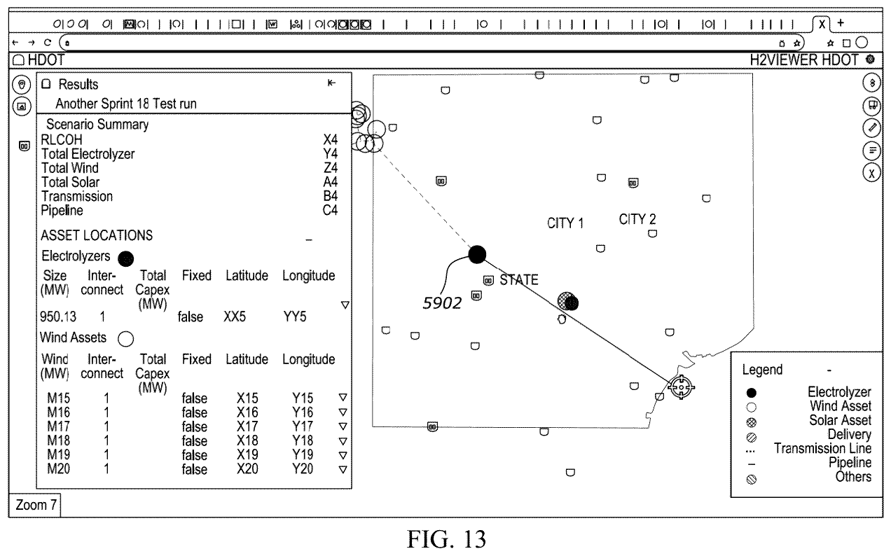

In this series, from FIG. 10 to FIG. 13, the proposed design of electrolyzer 1302 in FIG. 13 is the lowest cost per kilogram produced.

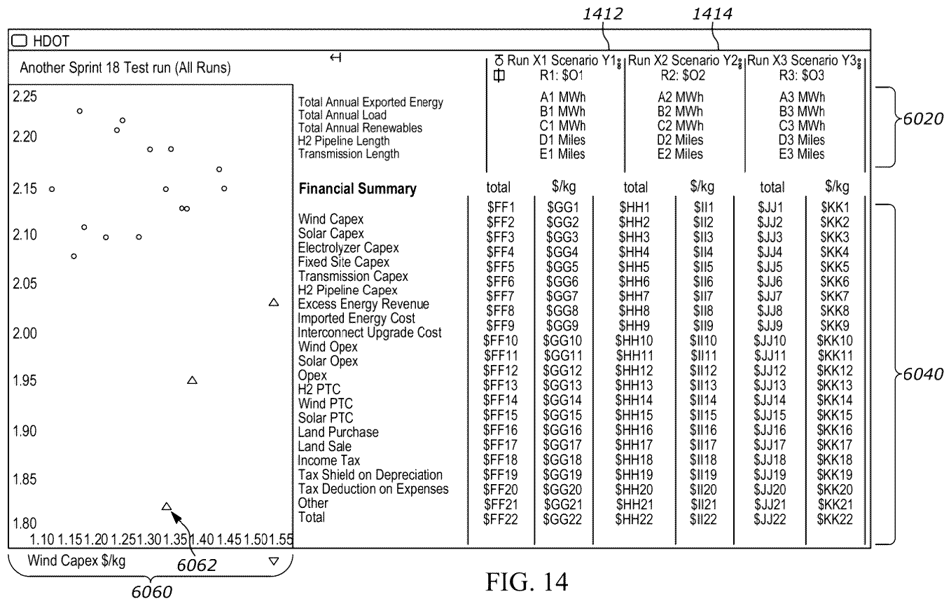

FIG. 14 is an interactive graphical user interface with a side-by-side comparison of the various permutations of designs created by FIG. 2 and the evaluations performed by FIG. 9. This interactive graphical user interface is broken down into three parts: top-right 1420, bottom-right 1440, and S/Kg for the electrolyzer part on the left 1460. Shown at the top-right part 1420 and then the financial summary information at the bottom-right 1440. The financial summary is the total cost of the hydrogen in terms of dollars per kilogram. A breakdown of cost contributions to the total system cost is calculated. The lowest point on graph 1462 illustrates the best nm on the graph here. Users can interactively select another point on the graph because, for example, the differences between two proposals 1412 and 1414, two runs, or two designs, is not that great (about 7%), and the comparison table is automatically created.

### Simulated Sizing and Siting

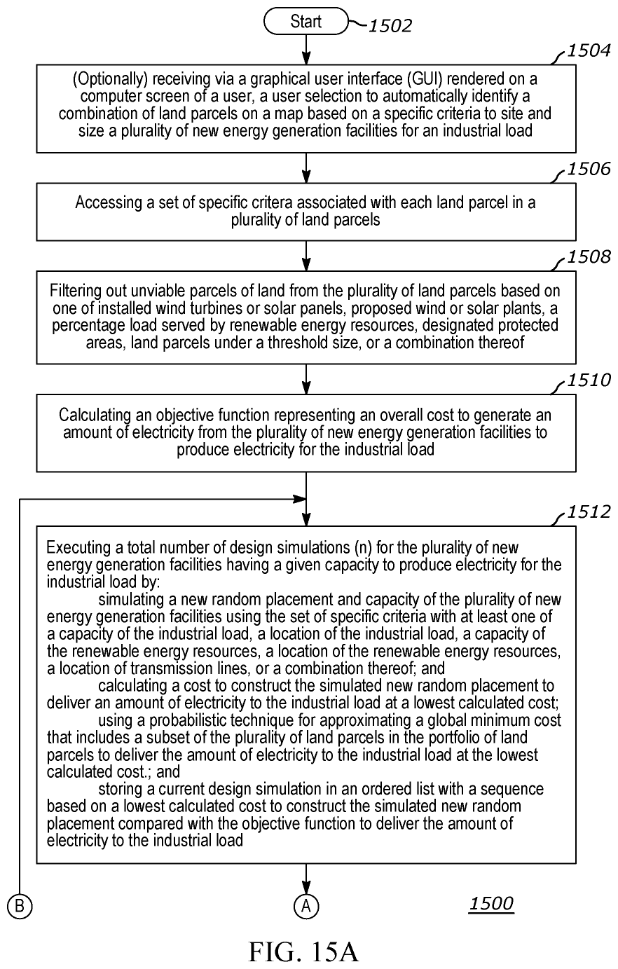

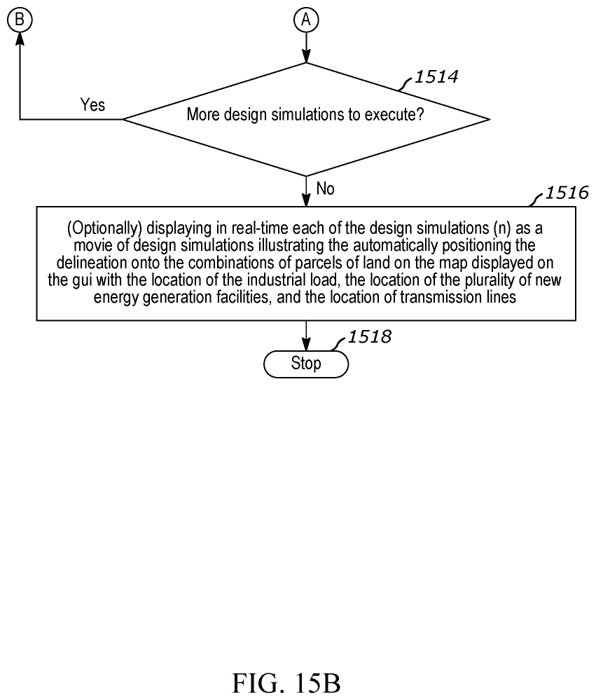

FIG. 15A and FIG. 15B is a flow chart 1500 for simulated sizing and siting of a plurality of new energy generation facilities to provide electricity for an industrial load. The process begins in step 1502 and immediately proceeds to step 1504.

Step 1504 is an optional step in which the system receives, via a graphical user interface (GUI) rendered on a user's computer screen, a user selection to automatically identify a combination of land parcels on a map based on specific criteria. The user request may include user input and/or user selections from options provided within the GUI. Options may include but are not limited to the type of new energy project, the desired capacity of the energy project, the total number of simulations to run, a time period for the simulations, a settable threshold for the clustering algorithm, graphical options to display in the GUI and more. The process continues to step 1506.

In step 1506, a set of specific criteria associated with each land parcel in the plurality of land parcels is accessed. The specific criteria are used to site and size the plurality of new energy generation facilities for an industrial load. In one aspect of the present invention, the specific criteria is one of the capacity of the industrial load, the location of the industrial load, the size of the renewable energy resources, and the location of the renewable energy resources, or a combination thereof. The process continues to step 1508.

In step 1508, unviable parcels of land from the plurality of land parcels are filtered out. The filtering is based on one of the installed wind turbines or solar panels, proposed wind or solar plants, a percentage load served by renewable energy resources, designated protected areas, land parcels under a threshold size, or a combination thereof. The process continues to step 1510.

In step 1510, an objective function representing an overall cost to generate an amount of electricity from the plurality of new energy generation facilities for the industrial load is calculated. The process continues to step 1512.

Step 1512 is a loop. The loop executes a total number of design simulations (N) for the plurality of new energy generation facilities having a given capacity to produce electricity for the industrial load. The design simulations (N) include four sub-steps. The first sub-step is simulating a new random placement and capacity of the plurality of new energy generation facilities using the set of specific criteria. The specific criteria include one or more of the capacity of the industrial load, a location of the industrial load, a capacity of the renewable energy resources, a location of the renewable energy resources, or a location of transmission lines. The specific criteria for an electrolyzer as the industrial load may further include the capacity of an electrolyzer and a source of renewable energy.

The second sub-step calculates the cost of constructing the simulated new random placement to deliver an amount of electricity to the industrial load at the lowest calculated cost. The costs calculated to construct the simulated placement may include capital costs to construct renewable energy sources, cost to construct electrolyzers and cost to construct a liquefier. The calculating of the costs may further include operating costs for all assets, transport of hydrogen by pipeline, trucking, and train, a market price of hydrogen, offset revenues in excess energy sales, hydrogen and clean hydrogen production tax credits (PTCs) or a combination thereof.

The third sub-step uses a probabilistic technique for approximating a global minimum cost that includes a subset of the plurality of land parcels in the portfolio of land parcels to deliver the amount of electricity to the industrial load at the lowest calculated cost. One example of a probabilistic technique for approximating a global minimum is a simulated annealing technique.

The probabilistic technique may include a subset of the plurality of land parcels in the portfolio of land parcels to deliver the amount of electricity to the industrial load at the lowest calculated cost further includes using one or more constraints of a minimum electrical generation capacity of the new energy generation facilities to deliver the amount of electricity to the industrial load as required by one of regional authorities. Independent System Operators (ISOs), Regional Transmission Organizations (RTOs), or a combination thereof.

The fourth sub-step is storing a current design simulation in an ordered list with a sequence based on the lowest calculated cost to construct the simulated new random placement compared with the objective function to deliver the amount of electricity to the industrial load. The process continues to step 1514.

In step 1514, a test is made if more design simulations are to be executed. The system could test the total number of simulations (N) are executed in parallel up to a total number of jobs or until a time period expires. The number of jobs or time period may be set by the user. The process continues to step 1516.

In step 1516, the results may be displayed in various formats with various color overlays on maps illustrating the combination of the parcels of land with the lowest calculated costs to construct the simulated new random placement compared with the objective function to deliver the amount of electricity to the industrial load. This may further comprise displaying in real-time each of the design simulations (N) as a movie of design simulations illustrating the automatic positioning of the delineation onto the combinations of parcels of land on the map displayed on the GUI with the location of the industrial load, the location of the plurality of new energy generation facilities, and the location of transmission lines. The process ends in step 1518.

### Information Processing System

The present subject matter can be realized in hardware, software, or a combination of hardware and software. A system can be realized in a centralized fashion in one computer system or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code, or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. Additionally, a computer medium may include volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information. In general, the computer readable medium embodies a computer program product as a computer readable storage medium that embodies computer readable program code with instructions to control a machine to perform the above-described methods and realize the above-described systems.

### General Computer for Implementing Algorithm

The present invention can be implemented on a standalone computer system, a server, a web-server, a cloud computing system or a hybrid cloud system, or other on-demand availability of computer system resources, especially data storage and computing power, without direct active management by the user.

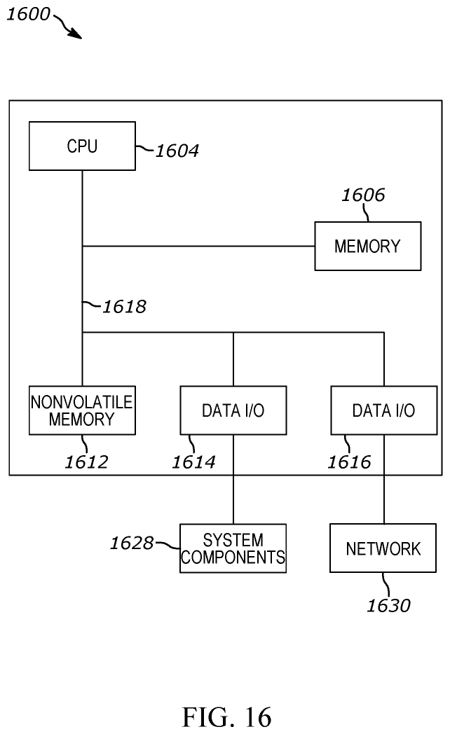

FIG. 16 illustrates a block diagram illustrating a processing system 1600 for carrying out a portion of the present invention, according to an example. The processor system 1600 is an example of a processing subsystem that is able to perform any of the above-described processing operations, other operations, or combinations of these, such as the flow diagram of FIG. 2, FIG. 9 and FIG. 15.

The processing system 1600 in this example includes a hardware processor or CPU 1604 that is communicatively connected to a main memory 1606 (e.g., volatile memory), a non-volatile memory 1612 to support processing machine instruction and operations. The CPU is further communicatively coupled to a network adapter hardware 1616 to support input and output communications with external computing systems such as through the illustrated network 1630.

The processor 1600 further includes a data input/output (I/O) processor 1614 that is able to be adapted to communicate with any type of equipment, such as the illustrated system components 1628. The data input/output (I/O) processor, in various examples, is able to be configured to support any type of data communications connections, including present-day analog and/or digital techniques or via a future communications mechanism. A system bus 1618 interconnects these system components.

### Non-Limiting Examples

Although specific embodiments of the subject matter have been disclosed, those having ordinary skill in the an will understand that changes are made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

All references listed in the information disclosure statement (IDS) are hereby incorporated by reference in their entirety.

What is claimed is:

1. A computer-implemented method for simulated sizing and siting of a plurality of new energy generation facilities to provide electricity for an industrial load, the method comprising:
i) accessing a set of specific criteria associated with each land parcel of a plurality of land parcels in a portfolio of land parcels
ii) filtering out unviable parcels of land from the plurality of land parcels based on one of installed wind turbines or solar panels, proposed wind or solar plants, a percentage load served by renewable energy resources, designated protected areas, land parcels under a threshold size, or a combination thereof;
iii) calculating an objective function representing an overall cost to generate an amount of electricity from the plurality of new energy generation facilities for the industrial load;
iv) executing a total number of design simulations (N) for the plurality of new energy generation facilities having a given capacity to produce electricity for the industrial load by:
simulating a new random placement and capacity of the plurality of new energy generation facilities using the set of specific criteria with at least one of a capacity of the industrial load, a location of the industrial load, a capacity of the renewable energy resources, a location of the renewable energy resources, a location of transmission lines, or a combination thereof; and
calculating a cost to construct the simulated new random placement to deliver an amount of electricity to the industrial load at a lowest calculated cost;
using a probabilistic technique for approximating a global minimum cost that includes a subset of the plurality of land parcels in the portfolio of land parcels to deliver the amount of electricity to the industrial load at the lowest calculated cost; and
storing a current design simulation in an ordered list with a sequence based on a lowest calculated cost to construct the simulated new random placement compared with the objective function to deliver the amount of electricity to the industrial load.

2. The computer-implemented method of claim 1, further comprising:
receiving, via a graphical user interface (GUI), a user selection to automatically identify a combination of land parcels in the portfolio of land parcels on a map, based on specific criteria, wherein the specific criteria is one of a capacity of the industrial load, the location of the industrial load, the size of the renewable energy resources, and the location of the renewable energy resources, or a combination thereof; and
outputting a display of an image of at least one parcel of land based on automatically positioning a delineation onto the combination of parcels of land on the map displayed on the GUI with the location of the industrial load, the location of the plurality of new energy generation facilities, and the location of transmission lines.

3. The computer-implemented method of claim 2, further comprising displaying in real-time each of the design simulations (N) as a movie of design simulations illustrating the automatically positioning the delineation onto the combinations of parcels of land on the map displayed on the GUI with the location of the industrial load, the location of the plurality of new energy generation facilities, and the location of transmission lines.

4. The computer-implemented method of claim 1, wherein the executing, using the probabilistic technique for approximating the global optimum, is a simulated annealing technique.

5. The computer-implemented method of claim 1, wherein the executing the total number of simulations (N) are executed in parallel up to a total number of jobs or until a time period expires.

6. The computer-implemented method of claim 5, wherein the total number of simulations, the time period, or both are settable by a user.

7. The computer-implemented method of claim 1, wherein the calculating the cost to construct the simulated placement further includes at one of
capital costs to construct renewable energy source, cost to construct electrolyzers, and cost to construct a liquefier;
operating costs for all assets;
transport of hydrogen by pipeline, trucking, and train;
a market price of hydrogen;
offset revenues in excess energy sales;
hydrogen and clean hydrogen production tax credits (PTCs); or
a combination thereof.

8. The computer-implemented method of claim 1, wherein the specific criteria further includes a capacity of an electrolyzer and a source of renewable energy.

9. The computer-implemented method of claim 1, wherein the using a probabilistic technique for approximating a global minimum cost that includes a subset of the plurality of land parcels in the portfolio of land parcels to deliver the amount of electricity to the industrial load at the lowest calculated cost further includes using one or more constraints of
a minimum electrical generation capacity of the new energy generation facilities to deliver the amount of electricity to the industrial load as required by one of regional authorities, Independent System Operators (ISOs), Regional Transmission Organizations (RTOs), or a combination thereof;
a minimum fraction of electricity supplied by renewable energy sources;
a maximum length of transmission lines; or
a combination thereof.

10. A system for simulated sizing and siting of a plurality of new energy generation facilities to provide electricity for an industrial load, the system comprising:
a computer memory capable of storing machine instructions; and
a hardware processor in communication with the computer memory, the hardware processor configured to access the computer memory to execute machine instructions for
i) receiving, via a graphical user interface (GUI), a user selection to automatically identify a combination of land parcels in the portfolio of land parcels on a map, based on specific criteria, wherein the specific criteria is one of a capacity of the industrial load, a location of the industrial load, the size of renewable energy resources, and the location of renewable energy resources, or a combination thereof
ii) accessing a set of specific criteria associated with each land parcel of a plurality of land parcels in a portfolio of land parcels
iii) filtering out unviable parcels of land from the plurality of land parcels based on one of installed wind turbines or solar panels, proposed wind or solar plants, a percentage load served by renewable energy resources, designated protected areas, land parcels under a threshold size, or a combination thereof;
iii) calculating an objective function representing an overall cost to generate an amount of electricity from the plurality of new energy generation facilities for the industrial load;
iv) executing a total number of design simulations (N) for the plurality of new energy generation facilities having a given capacity to produce electricity for the industrial load by:
simulating a new random placement and capacity of the plurality of new energy generation facilities using the set of specific criteria with at least one of a capacity of the industrial load, a location of the industrial load, a capacity of the renewable energy resources, a location of the renewable energy resources, a location of transmission lines, or a combination thereof; and
calculating a cost to construct the simulated new random placement to deliver an amount of electricity to the industrial load at a lowest calculated cost;
using a probabilistic technique for approximating a global minimum cost that includes a subset of the plurality of land parcels in the portfolio of land parcels to deliver the amount of electricity to the industrial load at the lowest calculated cost;
storing a current design simulation in an ordered list with a sequence based on a lowest calculated cost to construct the simulated new random placement compared with the objective function to deliver the amount of electricity to the industrial load; and
outputting a display of an image of at least one parcel of land based on automatically positioning a delineation onto the combination of parcels of land on the map displayed on the GUI with the location of the industrial load, the location of the plurality of new energy generation facilities, and the location of transmission lines.

11. The system of claim 10, further comprising displaying in real-time each of the design simulations (N) as a movie of design simulations illustrating the automatically positioning the delineation onto the combinations of parcels of land on the map displayed on the GUI with the location of the industrial load, the location of the plurality of new energy generation facilities, and the location of transmission lines.

12. The system of claim 10, wherein the executing, using the probabilistic technique for approximating the global optimum, is a simulated annealing technique.

13. The system of claim 10, wherein the executing the total number of simulations (N) are executed in parallel up to a total number of jobs or until a time period expires.

14. The system of claim 13, wherein the total number of simulations, the time period, or both are settable by a user.

15. The system of claim 10, wherein the calculating the cost to construct the simulated placement further includes at one of
capital costs to construct renewable energy source, cost to construct electrolyzers, and cost to construct a liquefier;
operating costs for all assets;
transport of hydrogen by pipeline, trucking, and train;
a market price of hydrogen;
offset revenues in excess energy sales;
hydrogen and clean hydrogen production tax credits (PTCs); or
a combination thereof.

16. The system of claim 10, wherein the specific criteria further includes a capacity of an electrolyzer and a source of renewable energy.

17. The system of claim 10, wherein the using a probabilistic technique for approximating a global minimum cost that includes a subset of the plurality of land parcels in the portfolio of land parcels to deliver the amount of electricity to the industrial load at the lowest calculated cost further includes using one or more constraints of
a minimum electrical generation capacity of the new energy generation facilities to deliver the amount of electricity to the industrial load as required by one of regional authorities, Independent System Operators (ISOs), Regional Transmission Organizations (RTOs), or a combination thereof;
a minimum fraction of electricity supplied by renewable energy sources;
a maximum length of transmission lines; or
a combination thereof.
